(19) United States
(12) Patent Application Publication
(10) Pub. No.: US 2024/0034497 A1
(43) Pub. Date: Feb. 1, 2024

(54) CONTACT INTERFACING MATERIAL RECEPTACLE

(71) Applicant: XEROX CORPORATION, Norwalk, CT (US)

(72) Inventors: Krishnan Thyagarajan, Sunnyvale, CA (US); Christopher Somogyi, Wimberley, TX (US); Sean Emerson Doris, San Francisco, CA (US)

(21) Appl. No.: 17/875,991

(22) Filed: Jul. 28, 2022

(51) Int. Cl. B65B 25/00; A23L 3/32; A23L 3/36

(52) U.S. Cl. CPC B65B 25/001; A23L 3/325; A23L 3/361; A23L 3/364

(57) ABSTRACT

A contact interfacing conductive receptacle is provided. The contact interfacing conductive receptacle includes a housing sized to receive an object including water. The housing includes one or more non-transfer material pieces and two or more transfer material pieces. Each transfer material piece is configured to provide conductivity and provides a field to a different portion of the object. The transfer material pieces are integrated with the non-transfer material pieces.

### FIELD

This application relates in general to packaging and in particular, to an electrode interfacing receptacle.

### BACKGROUND

Freezing is commonly used to preserve and store food and other organic material. Freezing involves keeping an object at sub-zero temperatures to minimize microbial damage of that object. However, during the process of freezing, unwanted chemical composition changes, nutritional damage and physical damage can occur in the object. Freezing is also time consuming and can be restricted to particular organic objects, rendering the process unavailable for some oil-based foods and objects with low water content.

The restrictions of freezing, including freeze drying, and refrigeration for preservation can both be overcome by supercooling, while permitting the advantages of both techniques to be present. Currently used supercooling techniques utilize fields, such as magnetic and electromagnetic fields, as described in U.S. Pat. No. 10,588,336, to Jun, to help preserve the physical, nutritional, and sensory characteristics of an object, such as a biological item, while subjecting the object to a temperature below the freezing point of water without freezing the object itself. This is enabled by the suppression or prevention of phase change of both intracellular and intercellular water in the intended object. The fields can include a pulsed/oscillating electric field, pulsed/oscillating magnetic field, or a combination of fields to reorient and induce agitation of water molecules in the object (among other physico-chemical controls), thus suppressing or preventing the formation of ice from the water molecules. Specifically, an electrical current or electric fields can be passed through an object being supercooled when the object is in direct contact with at least one electrode. Agitation can include vibration or excitement of the water molecules. However, when the object is a food item or beverage, direct contact with a contact, such as electrodes or magnets, can cause contamination, health issues, and aesthetic problems.

Accordingly, a receptacle that houses a food item, and has the ability to prevent the food item from directly touching electrodes, while compelling energy through or supplying energy to the food item is needed. Preferably, the receptacle is able to conform to the food item and evenly distribute energy.

### SUMMARY

During monitoring, a food item may directly touch a contact, such as an electrode, to enable an electrical current to be passed through or to supply energy to obtain information about a state of the food item. However, direct contact of a food item with an electrode is undesirable and can be a source of contamination. A contact interfacing receptacle can provide a barrier between the food item and electrode contact, while allowing fields from the electrode to supply energy or pass electrical currents, electric fields, magnetic fields, or magnetic currents through the food item.

An embodiment provides a contact interfacing conductive receptacle. The contact interfacing conductive receptacle includes a housing sized to receive an object including water. The housing includes one or more non-transfer material pieces and two or more transfer material pieces. Each transfer material piece is configured to provide conductivity and provides a field to a different portion of the object. The transfer material pieces are integrated with the non-transfer material pieces.

Other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing, by way of example, a system for feedback-based nucleation control.

FIG. 2 is a block diagram showing a device for nucleation control, in accordance with one embodiment.

FIG. 3A is a block diagram showing, by way of example, an electrode interfacing receptacle.

FIG. 3B is a block diagram showing, by way of example, a different configuration of the electrode interfacing receptacle of FIG. 3A.

FIG. 4 is a block diagram showing, by way of example, a different configuration of the electrode interfacing receptacle of 3A.

FIG. 5A is a block diagram showing, by way of example, a different configuration of the electrode interfacing receptacle of 3A.

FIG. 5B is a block diagram showing, by way of example, a different configuration of the electrode interfacing receptacle of 3A.

FIG. 6A is a block diagram showing, by way of example, a different configuration of the electrode interfacing receptacle of 3A.

FIG. 6B is a block diagram showing, by way of example, a different configuration of the electrode interfacing receptacle of 3A.

FIG. 6C is a block diagram showing, by way of example, a different configuration of the electrode interfacing receptacle of 3A.

FIG. 7 is a block diagram showing, by way of example, a roll of transfer material.

FIG. 8 is a block diagram showing, by way of example, a roll of electrode interfacing material, including transfer and non-transfer material.

FIG. 9 is a block diagram showing, by way of example, a different configuration of the roll of FIG. 8.

### DETAILED DESCRIPTION

When food items are undergoing processing or monitoring, the food item may require contact with one or more electrodes to pass electrical current through the food item or generate electrical fields to obtain data regarding a condition of the food item. For example, during the supercooling process, a water-containing food item is generally in direct contact with at least one electrode or other type of field generator, which generates a field that creates agitation or energization of water molecules in the food item to prevent nucleation, while cooling the food item to a temperature below freezing. However, direct contact between the food item and electrodes is undesirable and may cause contamination. An electrode interfacing receptacle can act as a barrier between the food item and electrodes, while facilitating the passing of an electrical field evenly through the food item to prevent nucleation during supercooling.

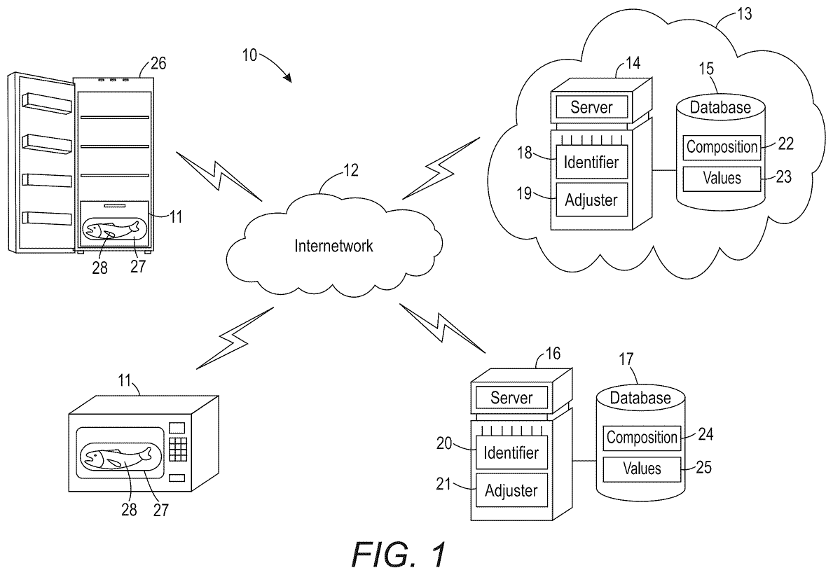

The electrode interfacing receptacle can be utilized with a feedback device to monitor and control the food item and fields during supercooling. FIG. 1 is a block diagram showing a system 10 for supercooling using a feedback device for nucleation control, in accordance with one embodiment. A supercooling device 11 can supercool an object 28, such as a food item or beverage, to a temperature below the freezing point of water without freezing the object by applying one or more fields to the object, including magnetic, electric, and electromagnetic fields. The object 28 can be placed directly in the supercooling device 11 or placed in an electrode interfacing receptacle 27 prior to placement in the supercooling device 11. The supercooling device 11 can be a standalone device or can be incorporated into an appliance, such as a refrigerator or another freezer 26.

The supercooling device 11 communicates with a feedback server 14, 16 via an internetwork 12, such as the Internet or cellular network, to obtain and adjust characteristics of the field based on the obtained characteristics. In one embodiment, the feedback server 14 can be a cloud-based server. Alternatively, the server 16 can be locally or remotely located with respect to the supercooling device 11. The feedback server 14, 16 can include an identifier 18, 20 and an adjuster 19, 21. The identifier 18, 20 can utilize measurements for characteristics of the object obtained from the supercooling device 11 to determine an identity or classification of the object based on known composition values 22, 24 of objects stored in a database 15, 17 associated with the server 14, 16. Machine learning can also be used in lieu of or in addition to a look up table of compositions and identities or classifications. In a further embodiment, identification or classification of an object can occur on the supercooling device 11, such as via a processor.

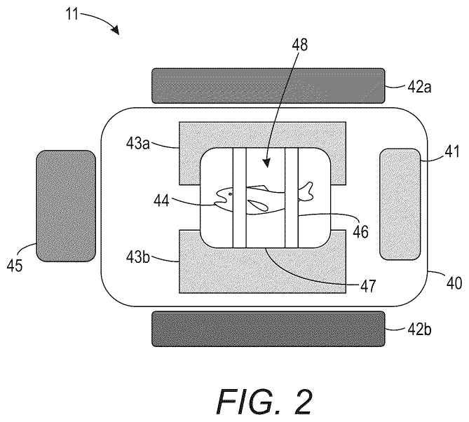

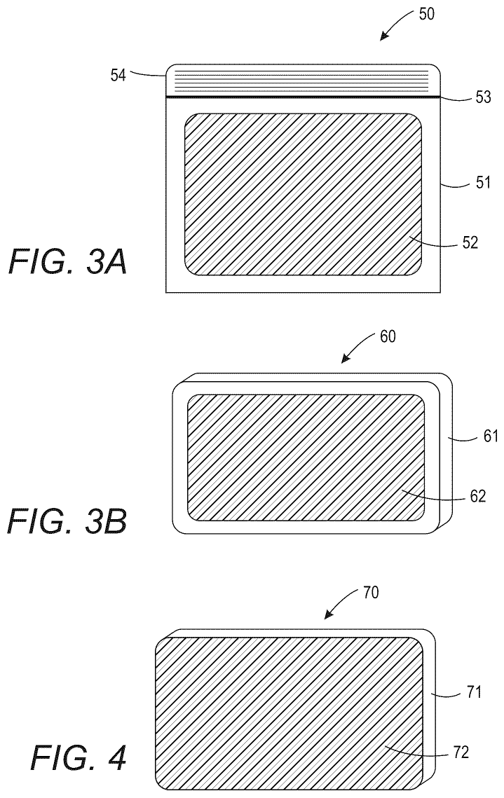

The adjuster 19, 21 can determine parameters for an initial field to be applied to the object 28 during supercooling based on an identity of the object 28. The fields can include magnetic, electric, and electromagnetic fields, such as via electrodes, magnets, or electromagnets, as further discussed below with references to FIG. 2. The electrode interfacing receptacle 27 can assist passing of the fields from the electrodes through the object 28, while the object is placed inside the receptacle and not in direct contact with the electrode. The electrode interfacing receptacle is further described below in detail with respect to FIGS. 3A-9.

While the initial field is applied, the adjuster 19, 21 can also utilize data obtained from the supercooling device 11 regarding the object and the field to determine whether the field should be adjusted to ensure an appropriate supercooling temperature is reached, without allowing nucleation of ice via the water content in the object. The adjustment can be determined using characteristic values 23, 25 for the object and parameter values for the field, which are stored by the databases 15, 17 to determine new parameter values for the field. In a further embodiment, ranges of object characteristics and field parameters can be stored on the supercooling device 11 for use in adjusting the supercooling fields applied to an object. Alternatively, machine learning can also be used to determine and adjust field parameters in lieu of a stored look up table of characteristic values and parameters.

The feedback device relies on one or more sensors to determine initial and updated field parameters, which are provided to contacts, including field generators, such as electrodes or magnets for applying to an object, such as a food item. FIG. 2 is a block diagram showing, by way of example a device for nucleation control, in accordance with one embodiment. The supercooling device 11 can include a repository 40 in which an object 44 is placed to undergo supercooling. The repository 40 can include a container, pan, or other type of repository for holding the object 44. In one embodiment, the repository 40 is placed into a standalone housing (not shown) or alternatively, can be incorporated into an appliance (not shown), such as a refrigerator or microwave. In yet a further embodiment, no repository is needed and the object 44 can be placed on a bottom surface of the supercooling device 11.

One or more field generators 42 a,b, 43 a,b can be positioned with respect to the repository 40. The field generators can each include a magnet, electrode, wires, electromagnets, or other material systems, such as 2D materials, including for example, graphene, van-der-waals layered materials or organic conductive polymers. At a minimum, the field generators should each be able to apply a field to an object 44 placed on or within the repository 40 to control nucleation, including preventing nucleation from occurring, via the field. For instance, the housing can include a compressor (not shown) for cooling the food item to a temperature between a range of −1° C. to −20° C. for preservation. The fields applied by the field generators initiate agitation or energization of water molecules in the food item to prevent nucleation or freezing, while the food item itself reaches temperatures below freezing. Initial values for parameters of the fields to be applied can be determined based on an identity of the object or a classification of the object, while further values of the parameters are based on monitored characteristics of the object to which the fields are applied.

One or more electrodes 43 a,b can be positioned on a bottom side of the repository 40, along an interior surface, to generate a pulsed electric field. Other positions of the electrodes are possible, including on opposite sides (not shown) of the repository 40. When placed in a position other than the bottom of the repository, the electrodes can be affixed to walls of the standalone housing or walls of a housing, such as an appliance. The electrodes can be positioned to contact the object or in a further embodiment, can be placed remotely from the object. In one embodiment, a pair of electrodes can be positioned across from one another, with the object placed between the pair of electrodes. Once positioned, the electrodes can provide an electric field to the object.

To prevent any direct contact between the food item 44 and the electrodes 43, the food item 44 can be placed in an electrode interfacing receptacle 47. The electrode interfacing receptacle 47 can include transfer material 46 that is capable of conductivity, including transferring electricity from the electrodes through the food item. Examples of the transfer material 46 can include metal, an organic semiconductor, aluminum, certain other metals, such as gold, silver or platinum, organic polymers, biocompatible conducting materials, and graphene, as well as other types of materials. However, at a minimum, the transfer material 46 should be food safe and able to withstand the current necessary to deliver an electrical field to the food item.

To ensure the transfer of the electrical field through the food item, areas of infinite impedance are present between each piece of transfer material. If different pieces of transfer material touch, a short circuit can occur and the current is unable to completely pass through the food item. The areas of infinite impedance can be present as a gap 48 between two or more pieces of transfer material placed on the food item 44 at different locations or as non-transfer material 48, which is placed in between pieces of transfer material. Different configurations of the transfer and non-transfer materials of the electrode interfacing receptacle are discussed below in further detail with respect to FIGS. 3A-9.

When placed in the repository or on a bottom surface of the supercooling device, the transfer material on one side of the receptacle can touch or contact electrodes in the repository or elsewhere in the supercooling device. The transfer material then touches a portion of the food item inside the receptacle. A different area of the food item is in contact with a separate piece of transfer material, such as on a separate side of the receptacle. If multiple receptacles are placed in the supercooling device, the transfer material pieces of different receptacles should not be in contact and placed accordingly.

The supercooling device 11 can also include at least one magnet 42 a, b, such as an electromagnet, a permanent magnet, or a combination of magnets, to generate an oscillating magnetic, electric or electromagnetic field for application to the object. Time-varying magnetic fields can be used to create electric fields and vice-versa. The magnets 42 a, b can be positioned adjacent to one or more sides of the repository 40, or can be affixed to the repository itself or the housing in which the repository is placed. In a further embodiment, the magnets can be remotely located from the repository and the field emitted from the magnets 42 a, b can be applied to the food item 44 via one or more transducers.

Further, at least one closed-loop monitoring sensor 41 can be provided adjacent to the repository on one or more sides. Alternatively or in addition, a sensor can be affixed to the housing, on an interior surface, in which the repository is placed for supercooling. The monitoring sensors can include imaging and reflective sensors, electrocurrent sensors, chemical sensors, electric sensors, acoustic sensors, optical sensors, electrochemical sensors, thermal sensors and imagers, and hyperspectral sensors. However, other types of sensors are possible. Data collected via the sensors can be used to monitor characteristics of the object during application of the fields and change the values of the field parameters, as part of a feedback process to control nucleation during supercooling.

An electrical control unit 45 can be a processor that is interfaced to the sensors 41, magnets 42 a,b, and electrodes 43 a,b to communicate during the feedback process. Specifically, the processor can determine an identity of or classify an object for supercooling based on measurements from the sensors 41, as well as identify parameters for the field to be applied based on the identity or classification. The processor 45 can also instruct the sensors 41 to measure characteristics of the object undergoing supercooling and in turn, receive the measured values as feedback for determining if new parameters of the field are needed and if so, values of the parameters. Based on the feedback from the sensors, the processor can communicate the new parameter values for the magnets and electrodes, to change the field applied to the object for changing the supercooling conditions.

In a further embodiment, the processor 45 can obtain data from the sensors, electrodes, and magnets for providing, via a wireless transceiver included in the device, to a cloud-based server for determining an identity or classification of the object, determining initial parameters for the field, and identifying new field parameters for adjusting the field. When performed in the cloud, the data set of object identities and classifications, initial values for the field parameters, and guidelines for adjusted parameters can be utilized by users of different devices. In contrast, when the processor of the supercooling device performs such actions, the data sets are specific to that supercooling device.

The components of the feedback device can vary in size depending on the food item to be supercooled. For large objects, the tray can be larger, as well as the magnets, while the electrodes may be placed further apart from one another due to the larger size of the objects or more electrodes may be used than for smaller objects. Further, a housing of the feedback device can also be dependent on the size of the components and the object.

Additionally, a size of the electrode interfacing receptacle, size of the transfer material, and configuration of the transfer and non-transfer materials can also depend on a size of the food item to be supercooled. For example, larger food items, such as a whole salmon requires a larger receptacle than a single chicken breast. Due to the larger size of the salmon, larger pieces or more pieces of transfer material may be used in the receptacle for the salmon than for the chicken breast. In one embodiment, around 80% of the food item should be covered by transfer material to ensure that the entire food item is supercooled in an even manner; however, other percentages of transfer material to food item are possible.

Different configurations of the transfer material may be desirable based on different types and shapes of food items. FIG. 3A is a block diagram showing, by way of example, an electrode interfacing receptacle 50. The receptacle 50 can resemble a plastic bag with a zip-type closure with tracks that can be sealed using fingers. The shape of the bag can include a square, rectangle, or other shape. The bag 50 can include transfer 52 and non-transfer 51 materials. At a minimum, the bag 50 should include at least two pieces of transfer material 52 that act as an anode and cathode and are positioned on different parts of the enclosed food item (not shown) to transfer fields from an electrode through an object, such as the food item, within the bag, and prevent short circuit. In a further embodiment, a single piece of transfer material can be used as long as the transfer material spans opposite sides of the food item and there are one or more areas that allow for infinite impedance, such as on the sides of the transfer material wrapped around the food item.

When two or more pieces of transfer material are used, one side of the receptacle bag can include one or more pieces of transfer material 52, each piece surrounded by non-transfer material 51. A shape and size of the transfer material can vary and can include a strip, rectangle, square, circle, or other shape. The other size of the receptacle bag can include one or more pieces of transfer material 52, each surrounded by non-transfer material 51 in the same or different configuration of the transfer and non-transfer materials of the first side.

The two sides of the receptacle bag can be affixed to one another on three of four sides with an adhesive, such as glue, or fused together, such as via heat, to form an opening on the unadhesed side. Other means for affixing the two sides together are possible. The open side of the receptacle bag can include a closure and tabs for opening the bag. The closure 53 can include male and female sides that fit together when in a closed position and can be sealed using a moveable tab, like a zipper, or when pressed together. Other types of closures 53 are possible. On one side of the closure 53, opposite the transfer and non-transfer materials, can be a tab 54 affixed to each side of the closure to allow a user to open the receptacle bag.

As described above, different types of transfer material can be included, including metal, aluminum, tin, and organic semiconductors. Depending on the type, the transfer material can be transparent so the enclosed food item is visible. Similarly, the non-transfer material can also be transparent depending on the type of material used. Types of non-transfer material can include plastic, silicone, insulating dielectrics, doped semiconductors whose conductivity has been modified to make it non-conducting (e.g., indium tin oxide). Both the transfer and non-transfer material should be food grade safe.

In one embodiment, the transfer material can be elastic or stretchy to conform to the food item to prevent different transfer material pieces from touching. However, the non-transfer material should be fairly sturdy to provide structure to the bag and prevent the surrounding pieces of transfer material from touching. In a further embodiment, a shape of the bag can be conformable, such that the bag conforms to the food item based on an increase or decrease in surrounding temperature. For example, transfer material made of elastic or polymer can be engineered to become more conformable as the temperature of the bag increases or decreases. For supercooling, the transfer material can become more conformable as the temperature decreases. Thus, the transfer material can conform to an unknown shape based on the food item and temperature of the material. Further, the temperature of the bag can be independent of the temperature of the food inside the bag. Shape memory material can also be used to conform to the food object during supercooling.

In a further example, the electrode interfacing receptacle can be in the shape of a box. FIG. 3B is a block diagram showing, by way of example, a different configuration 60 of the electrode interfacing receptacle of FIG. 3A. The electrode interfacing receptacle 60 can have a box shape and include two or more sides with one or more pieces of transfer material surrounded by non-transfer material. In one example, top and bottom (not shown) sides can each include one or more pieces of transfer material 62 surrounded by non-transfer material 61, while the four sides positioned between the top and bottom sides can be non-transfer material. To place the food item within the receptacle 60, the top can swing open, such as via a hinge, or taken off. In a further embodiment, one or more sides of the receptacle 60 can be open to allow placement of the food item.

The entire receptacle cannot be made of transfer material since one or more areas of infinite impedance are required so the current is passed completely through the food item. However, one or more entire sides of the receptacle can be transfer material. FIG. 4 is a block diagram showing, by way of example, a different configuration 70 of the electrode interfacing receptacle of 3A. The electrode interfacing receptacle 70 can have a box shape with four sides positioned between top and bottom sides. One of the sides can be made from transfer material 72, while the opposite side of the box can also include only transfer material 72. The remaining sides can be non-transfer material 71. In a further embodiment, additional sides can also be fully transfer material.

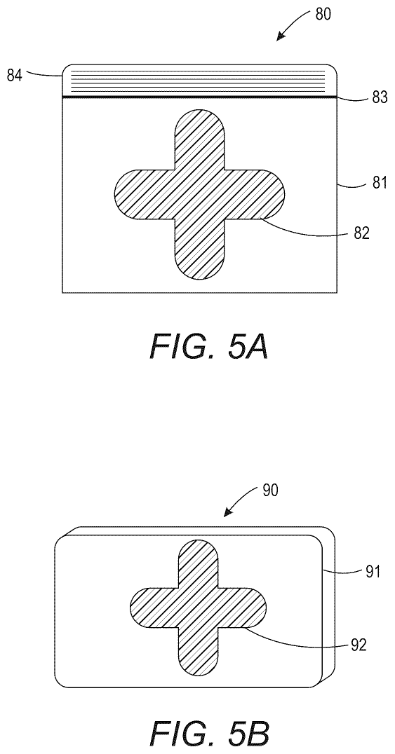

The transfer material can also be included in the electrode interfacing receptacle in different shapes. FIG. 5A is a block diagram showing, by way of example, a different configuration 80 of the electrode interfacing receptacle of 3A. The electrode interfacing receptacle 80 can have a ziplock brand bag shape and include two sides, each side including at least one piece of transfer material 82 surrounded by non-transfer material 81. In this example, the transfer material 82 can include a cross-like shape. However, in a further embodiment, the non-transfer material 81 can include a cross-like shape and the transfer material 81 can surround the cross-shaped non-transfer material. The bag can be opened and closed using a closure 83 and tabs 84, as described above with reference to FIG. 3A.

The cross-like shape of the transfer material can also be used on the electrode interfacing receptacle when in box form. FIG. 5B is a block diagram showing, by way of example, a different configuration 90 of the electrode interfacing receptacle of 3A. The electrode interfacing receptacle 90 can be shaped like a box or other six-sided shape, and includes a cross-like shaped piece of transfer material 92 surrounded by non-transfer material 91 on two or more sides of the box receptacle 90. In a further embodiment, two or more of the sides can each include a cross-like shape of non-transfer material 91 surrounded by transfer material 92. In yet a further embodiment, the transfer material 91 provided on each of the two or more sides of the box 90 can have different shapes.

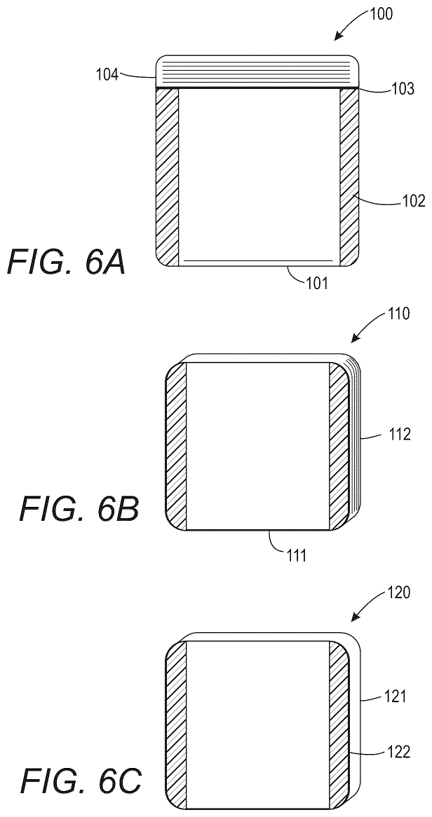

The transfer material can also continue around multiple sides of the electrode interfacing receptacle, rather than remain solely on one or more individual sides, as described above. FIG. 6A is a block diagram showing, by way of example, a different configuration 100 of the electrode interfacing receptacle of 3A. The electrode interfacing receptacle can be shaped similar to a ziplock brand bag with two sides fused together along three of the four edges. The open edge can include a closure 103 that allows access in and out of the bag. Specifically, when in a closed position, the closure 103 can be opened by pulling two tabs 104 apart. One side of the bag can include a strip of transfer material 102 on two of the edges that extends around to the other side in the same or different configuration, while non-transfer material 101 is present in the middle of the sides between the two pieces of transfer material 102 along the two edges.

In a different embodiment, FIG. 6B is a block diagram showing, by way of example, a different configuration 110 of the electrode interfacing receptacle of 3A. The electrode interfacing receptacle 110 can have a box-like shape. Two strips of transfer material 112 can be placed along two edges of one side of the box and extend across another side of the box over at least a portion of a side opposite the one side. For example, the strips can be placed on a top side of the box and extend to the back side of the box, over a side positioned between the front and back sides.

Alternatively, the two strips of transfer material do not extend from one side to another. FIG. 6C is a block diagram showing, by way of example, a different configuration 120 of the electrode interfacing receptacle of 3A. The electrode interfacing receptacle 120 can be in the shape of a box and include two pieces of transfer material 122 along two edges of one side. A middle of the side, between the two pieces of transfer material 122, can be non-transfer material 121. The other side of the bag can have the same configuration of transfer and non-transfer materials or a different configuration.

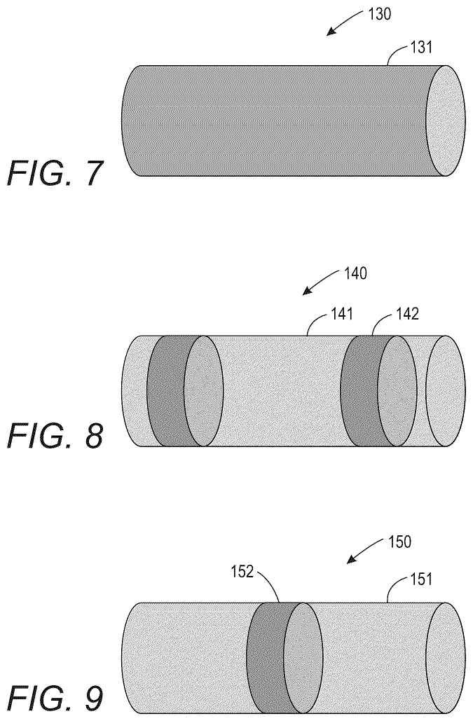

Rather than a receptacle for housing the food item, the transfer material can be placed on the food time, like foil, to act as a barrier between the food item and electrodes. FIG. 7 is a block diagram showing, by way of example, a roll 130 of transfer material 131. The transfer material 131 can be rolled around a tube and can be cut off at desired lengths using a box with a blade, similar to aluminum foil or via scissors. A piece of the transfer material 131 can be cut and placed on a bottom surface of the food item, such as between the food item and the repository or bottom surface of the supercooling device. Another piece of the same or different shape and size can be cut and placed on a top surface of the food item to compel energy from the electrodes in the repository or supercooling device to pass through the food item. The two pieces should not touch to create areas of infinite impedance, such as without the use of non-transfer material, and can be sized depending on the user or the food item. In a further, embodiment, more than two pieces of transfer material can be used.

Non-transfer material can also be used in the roll. FIG. 8 is a block diagram showing, by way of example, a roll 140 of electrode interfacing material, including transfer 142 and non-transfer 141 material. The roll 140 includes non-transfer material 141 with two stripes of transfer material 142. Since non-transfer material is included, the food item can be completely wrapped in the transfer and non-transfer material or pieces of the roll 140 can be cut and placed on the food item, as described above with reference to FIG. 7. Different configurations of the transfer and non-transfer materials are possible. FIG. 9 is a block diagram showing, by way of example, a different configuration 150 of the roll of FIG. 8. The roll 150 includes non-transfer material 151 with a single strip of transfer material 152. The material can be wrapped around the food item or cut to cover a top and bottom of the food item.

While the description above focuses on an electrode interfacing receptacle for food or beverage items, the receptacle can also be used for organs or other objects that are sensitive to contamination. For example, the receptacle can be sterilized for holding and preserving an organ until transplant. The receptacle can also be used for other objects, including, raw, preserved or cooked foods, blood, embryos, vaccines, probiotics, medicines, sperm, tissue samples, plant cultivars, cut flowers and other plant materials, biological samples of plants, animal, microbial, and fungal materials, non-biologicals, such as hydrogel materials, material that can be impacted by water absorption, such as textiles, nylons and plastic lenses and optics, fine instruments and mechanical components, heat exchangers, and fuel, as well as carbonated beverages as described in commonly-assigned U.S. patent application, entitled “System and Method for Feedback-Based Beverage Supercooling,” Ser. No. ______, filed Jul. 28, 2022, pending; ice as described in commonly-assigned U.S. patent application, entitled “System and Method for Controlling Crystallized Forms of Water,” Ser. No. ______, filed Jul. 28, 2022, pending; organic items as described in commonly-assigned U.S. patent application, entitled “System and Method for Feedback-Based Nucleation Control,” Ser. No. ______, filed Jul. 28, 2022, pending and commonly-assigned U.S. patent application, entitled “Feedback-Based Device for Nucleation Control,” Ser. No. ______, filed Jul. 28, 2022, pending, colloids as described in commonly-assigned U.S. patent application, entitled “System and Method for Feedback-Based Colloid Phase Change Control,” Ser. No. ______, filed Jul. 28, 2022, pending; agriculture as described in commonly-assigned U.S. patent application, entitled “System and Method for Controlling Cell Functioning and Motility with the Aid of a Digital Computer,” Ser. No. ______, filed Jul. 28, 2022, pending; meat as described in commonly-assigned U.S. patent application, entitled “System and Method for Controlling Cellular Adhesion with the Aid of a Digital Computer,” Ser. No. ______, filed Jul. 28, 2022, pending; and food as described in commonly-assigned U.S. patent application, entitled “System and Method for Metamaterial Array-Based Field-Shaping,” Ser. No. ______, filed Jul. 28, 2022, pending the disclosures of which are incorporated by reference.

While the invention has been particularly shown and described as referenced to the embodiments thereof, those skilled in the art will understand that the foregoing and other changes in form and detail may be made therein without departing from the spirit and scope of the invention.

What is claimed is:

1. A contact interfacing conductive receptacle, comprising:
a housing sized to receive an object comprising water and comprised of material, comprising:
one or more non-transfer material pieces; and
two or more transfer material pieces each configured to provide conductivity and integrated with the non-transfer material pieces, wherein each piece of transfer material provides a field to a different portion of the object.

2. A contact interfacing conductive receptacle according to claim 1, wherein each piece of transfer material interfaces with a contact that produces the field.

3. A contact interfacing conductive receptacle according to claim 2, wherein the contact comprises an electrode or conductive material.

4. A contact interfacing conductive receptacle according to claim 1, wherein the housing is configured for placement within a supercooling device.

5. A contact interfacing conductive receptacle according to claim 1, wherein the transfer material pieces are in contact with the object.

6. A contact interfacing conductive receptacle according to claim 1, wherein the housing comprises a box shape.

7. A contact interfacing conductive receptacle according to claim 6, wherein the box shape comprises two or more sides that each comprise at least one non-transfer material piece and at least one transfer material piece.

8. A contact interfacing conductive receptacle according to claim 7, wherein the non-transfer and transfer material pieces of the sides are arranged in a same or different configuration.

9. A contact interfacing conductive receptacle according to claim 1, wherein the housing comprises a bag with two sides.

10. A contact interfacing conductive receptacle according to claim 9, wherein each side of the bag comprises at least one piece of the non-transfer material and at least one piece of the transfer material.

11. A contact interfacing conductive receptacle according to claim 10, wherein the non-transfer and transfer material pieces of the sides are arranged in a same or different configuration.

12. A contact interfacing conductive receptacle according to claim 1, wherein the housing is in contact with a contact.

13. A contact interfacing conductive receptacle according to claim 12, wherein the contact comprises one of an electrode or magnet.

14. A contact interfacing conductive receptacle according to claim 1, wherein the transfer and the non-transfer material pieces comprise same or different shapes.

15. A contact interfacing conductive receptacle according to claim 1, wherein the food item is cooled to a temperature range comprising −1° C. to −20° C.

16. A contact interfacing conductive receptacle according to claim 1, wherein the field creates agitation or energization of the water in the food item to prevent nucleation when the food item is in the temperature range.

17. A contact interfacing conductive receptacle according to claim 1, wherein the field comprises at least one of an electric field, electric current, magnetic field, and magnetic current.

18. A contact interfacing conductive receptacle according to claim 1, wherein the pieces of transfer material comprise the same shape.

19. A contact interfacing conductive receptacle according to claim 1, wherein the pieces of transfer material comprise different shapes.

20. A contact interfacing conductive receptacle according to claim 1, wherein an opening is formed on one side of the housing.
